(19) United States
(12) Patent Application Publication
(10) Pub. No.: US 2019/0368256 A1
(43) Pub. Date: Dec. 5, 2019

(54) LIFT-TURN DOOR

(71) Applicant: Arconic Inc., Pittsburgh, PA (US)

(72) Inventor: Nick A. de Lange, Apeldoorn (NL)

(73) Assignee: Arconic Inc., Pittsburgh, PA (US)

(21) Appl. No.: 16/000,076

(22) Filed: Jun. 5, 2018

(51) Int. Cl. E05F 1/12; E05F 3/22; E05B 1/00; E05D 3/02; E05D 7/084

(52) U.S. Cl. CPC E05F 1/1253; E05F 3/226; E05D 7/084; E05D 3/022; E05B 1/0053

(57) ABSTRACT

A door assembly includes a door positionable within an opening defined in a wall, a bottom seal mounted to one of a bottom of the door and an underlying surface to generate a sealed interface at the underlying surface when the door is in a closed position, and a linkage operatively coupled to the door and actuatable to lift the door upwardly relative to the underlying surface and thereby separate the bottom seal from the other of the bottom of the door and the underlying surface.

### BACKGROUND

Hinged swinging doors commonly pivot between open and closed positions along one vertical edge and close against a doorjamb that forms part of the doorframe. In some designs, the doorjamb can provide a “rebate” which consists of a protruding edge designed to receive and stop the door in the closed position. The rebate typically overlaps the face of the door a short distance and thereby helps to minimize drafts on the top and sides of the door without requiring that the door be fitted too tightly within the doorframe. With a properly fitted door, there is little or no friction between the door and the doorframe at the top and the sides.

The construction at the bottom of the door, however, can be different. At the bottom, the door moves laterally relative to the underlying surface, such as a threshold or the bare floor. In designs that incorporate a threshold, the threshold might form a bottom portion of the door rebate to help stop the door in the closed position and provide a seal. To allow the door to pivot between the open and closed positions, a clearance is commonly provided between the bottom surface of the door and the underlying surface. This clearance can allow migration (ingress) of dust, dirt, and water past the door, and weather stripping is commonly attached to the underside of the door to mitigate this occurrence. Even with the incorporation of weather stripping, however, there is often a draft between the bottom of the door and the underlying surface.

### SUMMARY OF THE INVENTION

A door assembly is disclosed herein and may include a door positionable within an opening defined in a wall, a bottom seal mounted to one of a bottom of the door and an underlying surface to generate a sealed interface at the underlying surface when the door is in a closed position. A linkage may be operatively coupled to the door and actuatable to lift the door upwardly relative to the underlying surface and thereby separate the bottom seal from the other of the bottom of the door and the underlying surface.

A method is also disclosed herein that may include actuating a linkage operatively coupled to a door positioned within an opening defined in a wall, and thereby lifting the door upwardly relative to an underlying surface. A sealed engagement between a bottom seal mounted to one of a bottom of the door and the underlying surface may be released as the door is lifted upwardly. The door may then be rotated from a closed position to an open position.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a schematic front view of an example door assembly, according to one or more embodiments of the present disclosure.

FIG. 2 is a partial schematic diagram of the door assembly of FIG. 1 with the door in a partial open position and with an upper portion of a wall removed for ease of view, according to one or more embodiments.

FIGS. 3A-3D are progressive operational views of actuating the door handle of FIG. 2 to lift the door of FIG. 2.

FIG. 4 is a schematic front view of another example door assembly, according to one or more embodiments of the present disclosure.

FIG. 5 is a partial schematic diagram of another example door assembly, according to one or more additional embodiments.

### DETAILED DESCRIPTION

The present disclosure is related to swinging doors and, more particularly, to door assemblies that achieve a fluid tight seal at the bottom of the door by lowering the entire door to engage a bottom-mounted seal.

The embodiments discussed herein describe door assemblies having a door that operates as a common swinging door, but that may achieve a fluid-tight (e.g., water and air) seal at its bottom by lowering the door downward to engage a bottom-mounted seal. The bottom-mounted seal of the door may be arranged on the underside of the door, in contrast to seals positioned on the face of the door to seal around the side and top periphery of the door. The presently disclosed door assemblies may be advantageous in that no rebate is required at the bottom of the door for facilitating the fluid-tight seal. Rather, all that may be needed is a contact area on the underlying surface. This may allow for a completely barrier free door, which can still reach high air and weather tightness values. Moreover, the principles of the present disclosure allow for a door assembly with a continuous (uninterrupted) seal, which further enhances air and weather tightness capabilities.

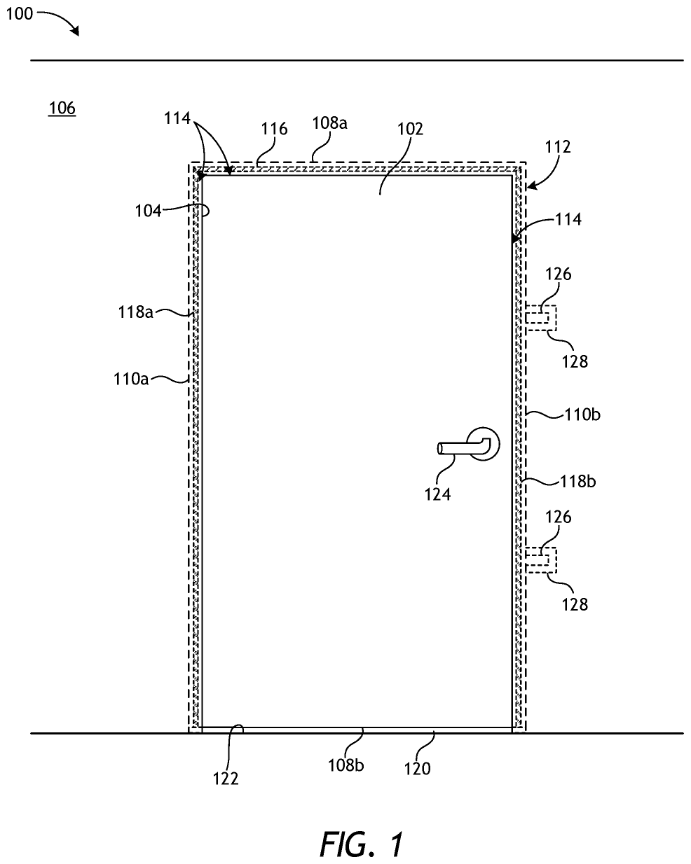

FIG. 1 is a schematic front view of an example door assembly 100, according to one or more embodiments of the present disclosure. As illustrated, the door assembly 100 may include a door 102 sized to occlude an opening 104 defined in a wall 106 or another type of vertically disposed barrier. The wall 106 may comprise any type of barrier that defines the opening 104 to accommodate or incorporate the door 102. In some embodiments, for example, the wall 106 may comprise a structural barrier commonly included in commercial or residential buildings, including a curtain wall, for example. In other embodiments, however, the wall 106 may comprise a fence or another barrier-type structure, without departing from the scope of the disclosure. Moreover, while only one door 102 is depicted in FIG. 1, the principles of the present disclosure are equally applicable to multiple (e.g., double) door configurations.

The door 102 includes a top 108a, a bottom 108b, and opposing sides 110a and 110b that extend between the top 108a and the bottom 108b. In some embodiments, the sides 110a,b may extend substantially vertical, but could alternatively be slanted, curved, etc., without departing from the scope of the disclosure. Moreover, while the corner transition between the sides 110a,b and the top 108a and the bottom 108b are depicted as 90° angles, the corners may alternatively be filleted or chamfered, without departing from the scope of the disclosure.

In some embodiments, a doorframe 112 may be provided in the opening 104 and may otherwise define the opening 104. The doorframe 112 may be sized to receive the door 102. In some embodiments, a rebate 114 may protrude (extend) inward a short distance from the inner periphery of the doorframe 112 to receive (stop) the door 102 when moved to the closed position. The rebate 114 may comprise a substantially planar edge or lip that is contiguous along at least the sides 110a,b and the top 108a of the doorframe 112. In other embodiments, however, the doorframe 112 may be omitted, and the opening 104 may alternatively be defined by the wall 106 with the rebate 114 protruding (extending) inward from the sides and the top of the opening 104. In either design, the rebate 114 may include at least top and side planar edges positioned to juxtapose the top 108a and the sides 110a,b of the front surface of the door 102.

When the door 102 is closed against the rebate 114, a substantially fluid-tight sealed interface may be generated on the front surface of the door 102 at the top 108a and the sides 110a,b. To enhance the fluid-tight seal, in some embodiments a seal structure may be provided at the interface between the front surface of the door 102 at the top 108a and the sides 110a,b and the opposing portions of the rebate 114. In the illustrated embodiment, for example, the door assembly 100 may include a top seal 116 and opposing side seals 118a and 118b. In some embodiments, as illustrated, the top and side seals 116, 118a,b may be coupled (mounted) to the front surface of the door 102 at the top 108a and the sides 110a,b. In other embodiments, however, the top and side seals 116, 118a,b may be coupled to the opposing top and side planar edges of the rebate 114. While only one seal is depicted for each of the top and side seals 116, 118a,b, more than one seal for one or each of the top and side seals 116, 118a,b may be employed, without departing from the scope of the disclosure.

The top and side seals 116, 118a,b may be contiguous at the corners of the door 102 (or the rebate 114) and thereby provide an uninterrupted seal along at least three peripheral edges of the door 102. The top and side seals 116, 118a,b may comprise any type of seal structure known to those skilled in the art of door manufacturing. Suitable materials for the top and side seals 116, 118a,b include, but are not limited to, an elastomer (e.g., a thermoplastic elastomer), a rubber (e.g., ethylene propylene diene monomer rubber or “EPDM,” chloroprene rubber, silicone rubber, etc.), a composite material, a fabric, insulation, or any combination thereof.

According to embodiments of the present disclosure, the door 102 may also provide a substantially fluid-tight sealed interface at the bottom 108b of the door 102, thus allowing the door 102 to reach elevated air and weather tightness values about the entire outer periphery. To enhance the fluid-tight seal, a bottom seal 120 may be mounted to the bottom 108b (e.g., the underside) of the door 102 and configured to seal against an underlying surface 122. When the door 102 is in the closed position, the weight of the door 102 at least partially urges the bottom seal 108b against the underlying surface 122 to generate the fluid-tight interface. In some embodiments, the side seals 118a,b may extend to the bottom 108b of the door 102 and fold under the door 102 to connect with the bottom seal 120. Consequently, the combined top, side, and bottom seals 116, 118a,b 120 may provide the substantially fluid-tight seal about the entire outer periphery of the door 102. Moreover, while only one bottom seal 120 is depicted, more than one bottom seal 120 may be employed, without departing from the scope of the disclosure.

In some embodiments, the underlying surface 122 may comprise a substantially flat and/or horizontal surface, such as the floor. As will be appreciated, however, the underlying surface need not be horizontal, but could alternatively be slanted or angled. The opening 104 may be substantially barrier and obstruction free at the underlying surface 122. In other embodiments, however, the underlying surface 122 may alternatively comprise a threshold secured to or otherwise forming an integral part of the floor. The threshold may alternatively form part of the doorframe 112. The threshold may or may not define a low profile. In at least one embodiment, for instance, a component may extend inward (e.g., vertically upward) from the threshold and may tie into the rebate 114. In other embodiments, however, the extending component may be omitted from the threshold to thereby provide a substantially barrier free area at the underlying surface 122.

According to embodiments of the present disclosure, the door 102 may be actuatable to raise the door 102 (and the bottom seal 120) relative to the wall 106 and the underlying surface 122. In some embodiments, for example, the door assembly 100 may include a handle 124 rotatably mounted to the door 102 and configured to be manually turned (manipulated) to actuate and raise (e.g., upwardly or vertically) the door 102. In other embodiments, however, the handle 124 may be omitted and the door 102 may be raised through automation, such as via electromechanical or other indirect means. Once the door 102 and the bottom seal 120 are raised from the underlying surface 122, the door 102 may be able to pivot from the closed position toward the open position without the bottom seal 120 engaging the underlying surface 122 and otherwise impeding rotational movement.

The bottom seal 120 may be made of similar materials as the top and side seals 116, 118a,b. When the door 102 is in the closed position, the combination of the top and side seals 116, 118a,b and the bottom seal 120 may provide the door 102 with a fluid-tight seal around each peripheral edge, and thus making the door highly impervious to fluid (e.g., gas and liquid) migration through the opening 104 in either direction. The door 102 is shown in FIG. 1 in a closed position. As used herein, the “closed position” refers to the door 102 occluding the opening 104 and the front surface (or alternatively the back surface) of the door 102 being positioned adjacent the opposing top and side planar edges of the rebate 114. In contrast, the “open position” refers to any position of the door 102 offset from the closed position. When the door 102 is in the “closed position,” the bottom seal 120 engages and provides a sealed interface against the underlying surface 122. Adequate pressure at the bottom seal 120 may be provided by the weight of the door 102.

In some embodiments, the top and side seals 116, 118a,b may be made of or otherwise incorporate a low-friction material, such as a coating. As used herein, “incorporating” the low-friction material may refer to, for example, the top and side seals 116, 118a,b either being made of the low-friction material or being coated with the low-friction material, or a combination thereof. In one embodiment, the low-friction material may comprise TEFLON®, for example. In other embodiments, however, the top and side seals 116, 118a,b may comprise any material but act on a low-friction material or surface. Incorporating a low-friction material (either in the top and side seals 116, 118a,b or on a surface contacted thereby) may prove advantageous in allowing the door 102 to be lifted upwardly without the top and side seals 116, 118a,b generating excessive frictional resistance to such movement at their sealing contact areas; e.g., the opposing top and side planar edges of the rebate 114 or the front surface of the door 102, depending on where the top and side seals 116, 118a,b are mounted. This may also help ease operation of the handle 124, which would otherwise require actuation (rotation) with a force that overcomes any frictional resistance of the top and side seals 116, 118a,b at the sealing contact areas.

In some embodiments, the door assembly 100 may further include rotation prevention members that help retain the door 102 in the closed position. One or more first rotation prevention members may be mounted to one of the door 102 and the wall 106, and one or more corresponding second rotation prevention members may extending laterally from a side of the other of the door 102 and the wall 106 and may be engageable with the one or more first rotation prevention members. More specifically, the door assembly 100 may include one or more rotation prevention pins 126 (two shown) extending laterally from the second side 110b of the door 102 and otherwise from the side of the door 102 opposite the side 110a that is coupled to the wall 106. The rotation prevention pins 126 may be configured to interact with corresponding rotation blocks 128 (two shown) embedded within or otherwise mounted to the wall 106. Similar to how a door latch operates, the rotation prevention pins 126 and the corresponding rotation blocks 128 may be configured to help retain the door 102 in the closed position. As described below, however, once the door 102 is raised, the rotation prevention pins 126 may be able to bypass the rotation blocks 128, which allows the door 102 to freely move from the closed position.

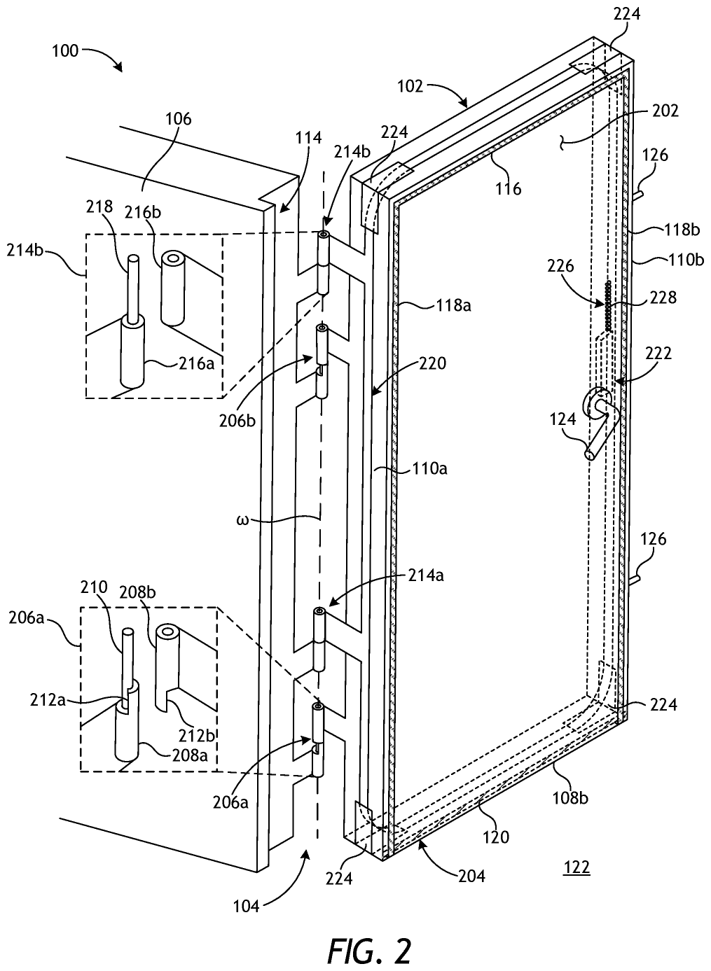

FIG. 2 is a partial schematic diagram of the door assembly 100 with the door 102 in an open position, according to one or more embodiments. As illustrated, one side member of the rebate 114 is depicted and extends inward from the wall 106 at the opening 104. The rotation prevention pins 126 are depicted extending laterally from the second side 110b of the door 102.

The top and side seals 116, 118a,b are each positioned on a front face 202 (or alternatively a back face) of the door 102, and the first side seal 118a is positioned to juxtapose the depicted corresponding member of the rebate 114 when the door 102 is in the closed position. While not shown in FIG. 2, the top seal 116 and the second side seal 118b may each be positioned to juxtapose corresponding top and side members of the rebate 114 when the door 102 is in the closed position. The bottom seal 120, however, is mounted (positioned) on an underside 204 of the door 102 at the bottom 108b. When the door 102 is in the closed position, the bottom seal 120 is urged against and forms a sealed interface at the underlying surface 122 and thereby achieves a fluid-tight seal at the bottom 108b of the door 102.

The door 102 is pivotably attached to the wall 106 with one or more multi-level hinges, shown as a first multi-level hinge 206a and a second multi-level hinge 206b. While two multi-level hinges 206a,b are depicted in FIG. 2, more or less than two may be employed, without departing from the scope of the disclosure. An exploded view of the first multi-level hinge 206a is shown in FIG. 2 in an enlarged inset graphic and is representative of the structure of both the first and second multi-level hinges 206a,b. Accordingly, the ensuing description of the first multi-level hinge 206a is equally applicable to the second multi-level hinge 206b.

As illustrated, the first multi-level hinge 206a includes a fixed hinge portion 208a and a movable hinge portion 208b pivotably coupled to the fixed hinge portion 208a with a pivot pin 210. The fixed hinge portion 208a may be coupled to or otherwise extend from the wall 106 (or the doorframe 112 of FIG. 1 if included), and the movable hinge portion 208b may be coupled to or otherwise extend from the door 102. The fixed hinge portion 208a may provide or define a first profile 212a and the movable hinge portion 208b may provide or define a second profile 212b that is matable with the first profile 212a. The profiles 212a,b may comprise, for example, complimentary cutouts formed in each hinge portion 208a,b. While only one matable profile (e.g., the first and second profiles 212a,b) is depicted in FIG. 2, more than one matable profile may be provided on the multi-level hinges 206a,b, without departing from the scope of the disclosure.

The fixed and movable hinge portions 208a,b may be adjusted and aligned such that when the profiles 212a,b are mated, the door 102 is in the closed position and the profiles 212a,b prevent the door 102 from pivoting to the open position. To move the door 102 to the open position, the door 102 must first be lifted (e.g., vertically) along a rotational axis ω of the door 102 to disengage the profiles 212a,b and thereby allow the movable hinge portion 208b to pivot relative to the fixed hinge portion 208a about the pivot pin 210. When the door 102 is in the open position, the profiles 212a,b become misaligned and may prevent the door 102 from returning (dropping) vertically downward along the rotational axis ω of the door 102.

As illustrated, the rotational axis ω of the door 102 extends through the multi-level hinges 206a,b. As used herein lifting or dropping the door 102 refers to moving (translating) the door 102 either up or down (e.g., vertically) along the rotational axis ω of the door 102.

The door 102 may also be pivotably attached to the wall 106 with one or more lifting hinges, shown as a first lifting hinge 214a and a second lifting hinge 214b. While two lifting hinges 214a,b are depicted in FIG. 2, more or less than two may be employed, without departing from the scope of the disclosure. An exploded view of the second lifting hinge 214b is shown in FIG. 2 in an enlarged inset graphic and is representative of the structure of both the first and second lifting hinges 214a,b. Accordingly, the ensuing description of the second lifting hinge 214b is equally applicable to the first lifting hinge 214a.

As illustrated, the second lifting hinge 214b includes a fixed lifting hinge portion 216a and a movable lifting hinge portion 216b pivotably coupled to the fixed lifting hinge portion 216a with a pivot pin 218. The fixed lifting hinge portion 216a may be coupled to or otherwise extend from the wall 106 (or the doorframe 112 of FIG. 1 if included), and the movable lifting hinge portion 216b may be operatively coupled to or otherwise extend from the door 102. The movable lifting hinge portion 216b may be directly or indirectly coupled to a mechanical linkage 220 (alternately referred to as a “linkage”) at least partially embedded within the door 102 and actuatable (movable) to help lift the door 102.

More specifically, the mechanical linkage 220 may comprise a continuous or semi-continuous structure at least partially embedded within the door 102 and operatively coupled to the handle 124 at a gearing assembly 222. Rotational movement of the handle 124 may be converted into linear movement of the mechanical linkage 220 via the gearing assembly 222. In other embodiments, however, as briefly mentioned above, the handle 124 may be omitted and linear movement of the mechanical linkage 220 may be accomplished through automation, such as via electromechanical or other indirect means. Corner drives 224 may be positioned at each corner of the door 102 to help redirect the orientation and linear movement of the mechanical linkage 220 and thereby enable the mechanical linkage 220 to extend about some or the entire periphery (circumference) of the door 102. The corner drives 224 may also operate to redirect the linear movement of the mechanical linkage 220 into a force or load applied to the lifting hinges 214a,b (i.e., the movable lifting hinge portions 216b).

In some embodiments, the mechanical linkage 220 may comprise, for example, a continuous band of material made of metal, plastic, or another rigid or semi-rigid material. In such embodiments, the movable lifting hinge portion 216b may be coupled to an exposed portion of the band positioned adjacent the first side 110a. In other embodiments, however, the mechanical linkage 220 may comprise a plurality of interconnected rigid or semi-rigid members, such as multiple interconnected rod or shaft members. In such embodiments, the movable lifting hinge portion 216b may be coupled to one of the interconnected members positioned adjacent the first side 110a. In yet other embodiments, the mechanical linkage 220 may alternatively comprise a cable under constant tension. In such embodiments, the movable lifting hinge portion 216b may be coupled to a cable at the first side 110a.

Actuating the mechanical linkage 220 may urge the movable lifting hinge portion 216b downward against the fixed lifting hinge portion 216a, which is fixed to the wall 106. Since the mechanical linkage 220 is at least partially embedded within the door 102, urging the movable lifting hinge portion 216b downward against the immovable fixed lifting hinge portion 216a correspondingly urges the door 102 in the opposite direction, i.e., upwardly as the mechanical linkage 220 shifts within the door 102. As the door 102 moves upward, the movable hinge portion 208b of each multi-level hinge 206a,b also moves upward relative to the fixed hinge portion 208a, and thereby disengages the profiles 212a,b of the multi-level hinges 206a,b. Fine adjustment of the multi-level hinges 206a,b is possible since the fixed hinge portion 208a of each multi-level hinge 206a,b is fixed to the wall 106. More specifically, fine adjustment of the profiles 212a,b may be possible, and thereby tuning the rotational position at which rotation of the door 102 is either blocked or allowed. This may be possible since one or both of the hinge portions 208a,b may be adjustable relative to one another and then fixed in place relative to either the wall 106 or the door 102, respectively.

As illustrated, the mechanical linkage 220 may originate and terminate at the gearing assembly 222. In other embodiments, however, the mechanical linkage 220 may extend from the gearing assembly 222 and terminate at one or both of the lifting hinges 214a,b, without departing from the scope of the disclosure. The gearing assembly 222 may operatively couple the handle 124 to the mechanical linkage 220 such that actuation or rotation of the handle 124 correspondingly actuates the mechanical linkage 220 and thereby urges the door 102 to move upward. Accordingly, rotating the handle 124 correspondingly lifts the door 102 off the underlying surface 122 and thereby disengages the bottom seal 120 to allow the door 102 to pivot to the open position.

In some embodiments, as illustrated, the gearing assembly 222 may comprise a type of rack and pinion gearing, where the rack is coupled to the mechanical linkage 220 and the handle 124 operates as the engaged pinion gear. In other embodiments, however, other types of gearing or lever systems may be incorporated, such as a power transmission system or the like, without departing from the scope of the disclosure.

In some embodiments, the door assembly 100 may further include a counterweight system 226 configured to aid in operating the door handle 124 to raise the door 102. More specifically, the counterweight system 226 may operate to lessen the amount of force required to rotate the handle 124 and thereby lift the door 102. Without the counterweight system 226, the door 102 would be lifted upwardly based solely on the rotational force applied to the handle 124.

In at least one embodiment, as illustrated, the counterweight system 226 may be arranged within the door 102 and may comprise a biasing device 228 that helps supplement (enhance) the linear driving force of the mechanical linkage 220. As illustrated, the biasing device 228 may comprise a tensioning spring coupled to the gearing assembly 222 at one end and coupled to the door 102 at the other end. As the gearing assembly 222 is actuated, the biasing device 228 applies a load on the door 102 and thereby augments a portion of the force transmitted to the mechanical linkage 220 to cause its linear movement. In other embodiments, the biasing device 228 may comprise a compression spring coupled to the opposite side of the gearing assembly 222. In yet other embodiments, the biasing device 228 may alternatively comprise a gas spring, an electromagnetic spring, a hydraulic or pneumatic system, or any combination of the foregoing. In even further embodiments, as discussed below, the counterweight system 226 and the corresponding biasing device 228 may be arranged adjacent or in conjunction with the multi-level and lifting hinges 206a,b and 214a,b. Alternatively, or in addition thereto, the biasing device 228 could also be connected directly to the mechanical linkage 220 (instead of the gearing mechanism 222) and the door 102. This may also allow free placement of the biasing device 228 relative to the door 102, for example on the top 108a or the bottom 108b. The biasing device 228 may also have a dampening effect that helps prevent excessively fast downward movement of the door 102 when moving the door 102 back to the closed (lowered) position.

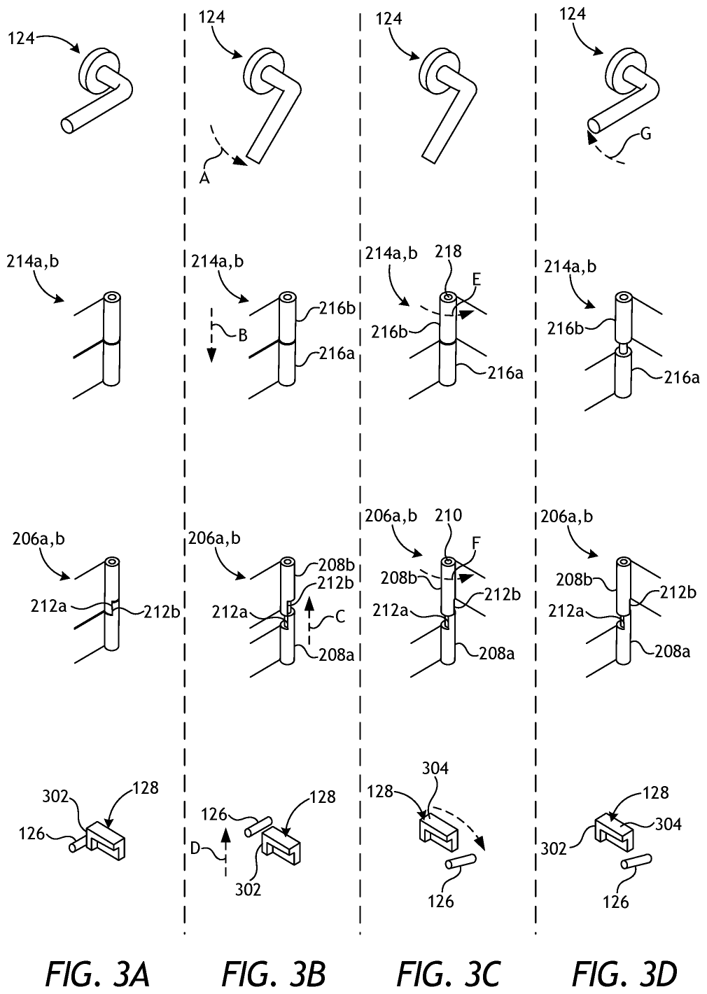

Referring now to FIGS. 3A-3D, with continued reference to FIG. 2, illustrated are progressive operational views of actuating the door handle 124 to lift the door 102 of FIG. 2, according to one or more embodiments. More specifically, FIGS. 3A-3D depict example operation of the door handle 124 and the resulting operation (movement) of the multi-level hinges 206a,b, the lifting hinges 214a,b, and the combination rotation prevention pin(s) 126 and rotation block(s) 128.

In FIG. 3A, the door 102 (FIG. 2) is in the closed position, as generally described above. In the closed position, the door handle 124 is released, the lifting hinges 214a,b are rotationally closed, and the multi-level hinges 206a,b are closed with the opposing profiles 212a,b in mating engagement. Furthermore, in the closed position, the rotation prevention pin(s) 126 may be arranged or otherwise positioned on a backside 302 of the rotation block(s) 128. The rotation prevention pin(s) 126 may engage the backside 302 of the corresponding rotation block 128, and thereby prevent the door 102 from moving to the open position.

In FIG. 3B, the door handle 124 is operated (engaged) by rotating it in the angular direction shown by the arrow A. It is contemplated herein, however, that the door handle 124 may alternatively be operated by rotating it in the opposite direction, or around a differently oriented axis. In other embodiments, operating the door handle 124 may entail a linear motion in any direction instead of rotational movement, as long as there is some input force applied to the door handle 124. The input force may be applied manually, or may alternatively be automated through the use of one or more servos or motors operated by a computer system. In embodiments where the door handle 124 is operated through automation, the servos and/or motors may also help engage the lifting hinges 214a,b, the mechanical linkage 220, and/or the gearing mechanism 222 directly. In such embodiments, the mechanical linkage 220 and/or the gearing mechanism 222 and/or the door handle 124 may be omitted.

As described above, the handle 124 is operatively coupled to the mechanical linkage 220 (FIG. 2) such that actuation of the handle 124 correspondingly actuates the mechanical linkage 220. Moreover, actuating the mechanical linkage 220 correspondingly urges the movable lifting hinge portion 216b of the lifting hinges 214a,b downward against the fixed lifting hinge portion 216a, as shown by the arrow B. Since the fixed lifting hinge portion 216a is fixed to the wall 106 (FIGS. 1 and 2) and the mechanical linkage 220 is at least partially embedded within the door 102 (FIG. 2) and possibly attached to the biasing device 228 (FIG. 1) and the gearing system 222 (FIG. 2) (and thus the door handle 124), the door 102 is correspondingly urged upward as the movable lifting hinge portion 216b pushes downward B against the fixed lifting hinge portion 216a.

As the door 102 (FIG. 2) moves upward, the movable hinge portion 208b of each multi-level hinge 206a,b also moves upward relative to the fixed hinge portion 208a, as shown by the arrow C. Moving the movable hinge portion 208b upward relative to the fixed hinge portion 208a may eventually disengage the mating profiles 212a,b of the multi-level hinges 206a,b, which may allow rotational movement of the door 102 unobstructed by the profiles 212a,b.

Furthermore, as the door 102 (FIG. 2) moves upward, the rotation prevention pin(s) 126 attached to the door 102 are correspondingly lifted upwardly, as shown by the arrow D, which may be substantially parallel to arrow C. More specifically, the rotation prevention pin(s) 126 may be lifted upward until moving out of lateral engagement (or close contact) with the backside 302 of the corresponding rotation block 128, at which point the rotation block(s) 128 no longer impede(s) rotation of the door 102.

Moreover, as the door 102 (FIG. 2) moves upward, the fluid-tight seal at the bottom 108b (FIG. 2) of the door 102 may also be broken. Raising the door 102 correspondingly raises the bottom seal 120 (FIG. 2) from the underlying surface 122 (FIG. 2), which allows the door 102 to pivot from the closed position without the bottom seal 120 obstructing or impeding rotational movement.

As mentioned above, upward/downward movement of the door 102 (FIG. 2) may be eased by using low-friction materials for the top and side seals 116, 118a,b (FIGS. 1 and 2), or on a surface contacted thereby, which minimizes frictional resistance to such movement at their sealing contact areas; e.g., the opposing top and side planar edges of the rebate 114 (FIGS. 1 and 2) or the front surface of the door 102, depending on where the top and side seals 116, 118a,b are mounted. Moreover, as also mentioned above, the counterweight system 226 (FIG. 2) may additionally help ease upward movement by partially bearing the weight of the door 102. In embodiments with the handle 124, this may prove advantageous in helping reduce the amount of force required to rotate the handle 124 in the angular direction A to lift the door 102.

In FIG. 3C, the door 102 (FIG. 2) has been moved from the closed position (i.e., opened) by rotating the door 102 at the multi-level and lifting hinges 206a,b and 214a,b. More specifically, the movable lifting hinge portion 216b of the lifting hinges 214a,b may be rotated relative to the fixed lifting hinge portion 216a in the angular direction E about the pivot pin 218. Similarly, the movable hinge portion 208b of the multi-level hinges 206a,b may be rotated relative to the fixed hinge portion 208a in the angular direction F, which may be substantially parallel to angular direction E, about the pivot pin 210.

Downward movement of the door 102 (FIG. 2) may be prevented by the misalignment of the profiles 212a,b of the multi-level hinges 206a,b. In some embodiments, downward movement of the door 102 (FIG. 2) may also be prevented at small opening angles by the rotation prevention pin 126 engaging a top surface 304 of the corresponding rotation block 128. More particularly, as the rotation prevention pin 126 traverses the top surface 304 of the corresponding rotation block 128, the door 102 will effectively be suspended in the raised position. At larger angles, however, the rotation prevention pin 126 will bypass the top surface of the rotation block 128 and downward movement of the door 102 may then be prevented exclusively by the misalignment of the profiles 212a,b of the multi-level hinges 206a,b.

In FIG. 3D, the door 102 (FIG. 2) has been rotated further from the closed position and downward movement of the door 102 may be correspondingly prevented by the misalignment of the profiles 212a,b of the multi-level hinges 206a,b. At this point, the door handle 124 may be released, if desired, and the door handle 124 may be biased to return to its initial position in the angular direction shown by the arrow G.

Releasing the handle 124 may also correspondingly release actuation of the mechanical linkage 220 (FIG. 2). Once the mechanical linkage 220 is released, the movable lifting hinge portion 216b of the lifting hinges 214a,b may no longer be urged downwardly against the corresponding fixed lifting hinge portion 216a. Consequently, the movable lifting hinge portion 216b may be allowed to separate from the fixed lifting hinge portion 216a as the mechanical linkage 220 reverses its linear movement and resets its position. In some embodiments, the movable lifting hinge portion 216b may alternatively be designed to stay in its lowered position when the door handle 124 is released (e.g., not separate from the fixed lifting hinge portion 216a when the mechanical linkage 220 reverses movement). In such embodiments, the movable lifting hinge portion 216b may be allowed to separate from a fixed position on the mechanical linkage 220.

The door 102 (FIG. 2) may be closed once again by reversing the foregoing steps. More specifically, as it is rotated back toward the closed position, the door 102 may be supported in the raised position by the misalignment of the profiles 212a,b of the multi-level hinges 206a,b. Operation of the door handle 124 may not be required during this return movement. Near the closed position, the door 102 may be maintained in the raised position at least partially by the rotation prevention pin 126 traversing (engaging) the top surface 304 of the corresponding rotation block 128. At the closed position, however, the rotation prevention pin 126 may bypass the top surface 304 of the rotation block 128 and the profiles 212a,b of the multi-level hinges 206a,b may become aligned once more. This may result in the door 102 falling downward to the closed position.

As the door 102 (FIG. 2) moves downwards, the fluid-tight seal at the bottom 108b (FIG. 2) of the door 102 may also be restored. More specifically, moving the door 102 downward correspondingly urges the bottom seal 120 (FIGS. 1 and 2) into engagement with the underlying surface 122 (FIGS. 1 and 2), which generates a fluid-tight seal at the interface. Once the door 102 is returned to the closed position, rotation away from the closed position is once again prevented by the aligned profiles 212a,b of the multi-level hinges 206a,b in combination with the rotation prevention pin 126 engaging the backside 302 of the rotation block 128. Accordingly, the rotation prevention pin 126 may effectively function as a locking bolt, for example.

The counterweight system 226 may help prevent excessively fast downward movement of the door 102 (FIG. 2). Excessively fast downward movement of the door 102 may also be prevented by friction generated by the top and side seals 116, 118a,b (FIGS. 1 and 2) engaging the opposing top and side planar edges of the rebate 114 (FIGS. 1 and 2), or alternatively engaging the front surface of the door 102 in embodiments where the top and side seals 116, 118a,b are positioned on the rebate 114.

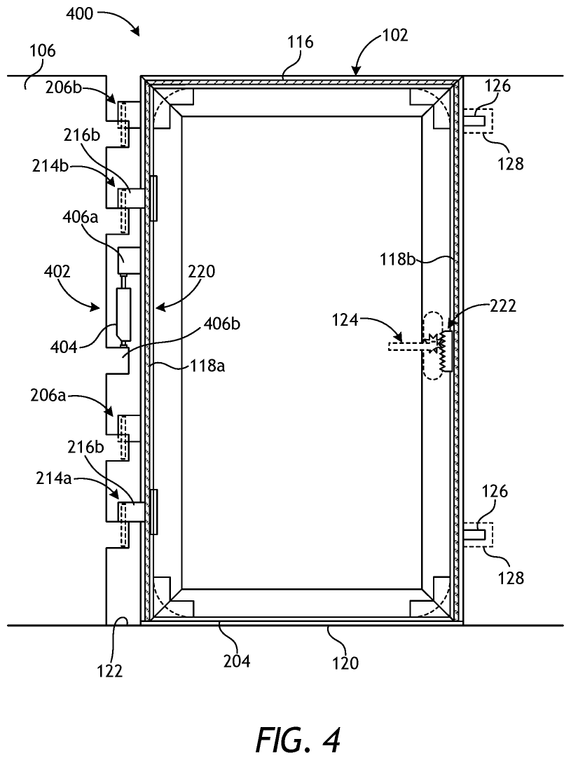

FIG. 4 is a schematic front view of another example door assembly 400, according to one or more embodiments of the present disclosure. The door assembly 400 may be similar in some respects to the door assembly of FIGS. 1 and 2 and, therefore, may be best understood with reference thereto, where like numerals will represent like components not described again in detail. As illustrated, the door assembly 400 may include the door 102 rotatably (pivotably) coupled to the wall 106 at the multi-level and lifting hinges 206a,b and 214a,b. The rebate 114 (FIGS. 1 and 2) is hidden to enable viewing of the hinges 206a,band 214a,b, but the top and side seals 116, 118a,b are shown positioned on the front surface of the door 102 to sealingly engage opposing top and side planar edges of the rebate 114. The bottom seal 120 may be mounted to the underside 204 of the door 102 to generate a sealed interface against the underlying surface 122, and the rotation prevention pins 126 may extend laterally from the door 102 to interact with the rotation blocks 128 embedded within or mounted to the wall 106. The movable lifting hinge portion 216b of each lifting hinge 214a,b may be operatively coupled (either directly or indirectly) to the mechanical linkage 220, which may be operatively coupled to the handle 124 at the gearing assembly 222.

As illustrated, the door assembly 400 may further include a counterweight system 402 operable to help lift the door 102 vertically, and thereby lessen the amount of force required to rotate the handle 124. In the illustrated embodiment, the counterweight system 402 is positioned external to the door and may comprise a biasing device 404 coupled to a first or “door” flange 406a and a second or “wall” flange 406b. More particularly, the biasing device 404 may interpose the door flange 406a and the wall flange. The door flange 406a is coupled to or otherwise extends from the first side 110a of the door 102, and the wall flange is coupled to or otherwise extends from the wall 106.

As illustrated, the biasing device 404 comprises a gas spring. In other embodiments, however, the biasing device 404 may alternatively comprise a compression spring. In yet other embodiments where the position of the flanges 406a,b are reversed (i.e., the wall flange 406b is above and the door flange 406a is below), the biasing device 404 may comprise a tensioning spring. In yet other embodiments, the biasing device 404 may alternatively comprise an electromagnetic spring, a hydraulic assembly, a pneumatic system, or any combination of the foregoing. In operation, the biasing device 404 provides an upward biasing force that may help supplement (enhance) the linear driving force of the mechanical linkage 220 to lift the door 102. The biasing device 404 may also have a dampening effect, helping prevent excessively fast downward movement of the door 102 when moving the door 102 back to the closed (lowered) position.

In at least one embodiment, the counterweight system 402, or the counterweight system 226 of FIG. 2, may be integrated into the multi-level hinges 206a,b. More specifically, one or both of the biasing devices 228 (FIGS. 2) and 404 may interpose the fixed and movable hinge portions 208a,b of the multi-level hinges 206a,b. Alternatively, one or both of the biasing devices 228 and 404 may be coupled to the fixed and movable hinge portions 208a,b in a manner that provides an upward biasing force that may help supplement (enhance) the linear driving force of the mechanical linkage 220 to lift the door 102.

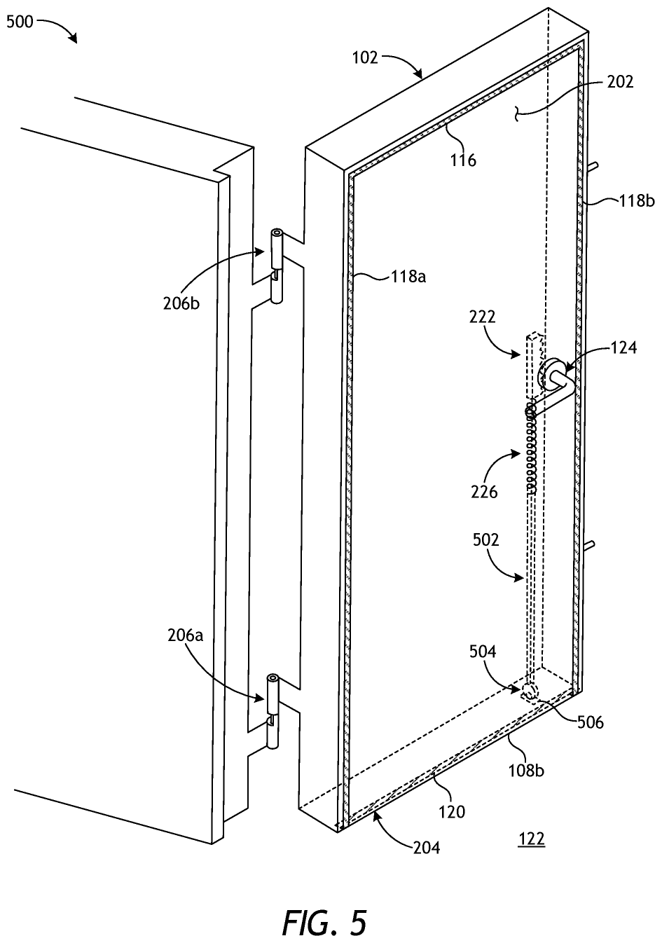

FIG. 5 is a partial schematic diagram of another example door assembly 500, according to one or more additional embodiments. The door assembly 500 may be similar to the door assembly 100 of FIGS. 1 and 2 and therefore may be best understood with reference thereto, where like numerals correspond to like components not described again. Similar to the door assembly 100, for example, the door assembly 500 includes the door 102 with the top and side seals 116, 118a,b positioned on the front face 202 (or alternatively a back face) of the door 102, and the bottom seal 120 is mounted (positioned) on the underside 204 of the door 102 at the bottom 108b. The door assembly 500 also includes the multi-level hinges 206a,b as generally described above, but could alternatively only include one of the multi-level hinges 206a,b (or more than two). Moreover, the door assembly 500 may further include the door handle 124 and the gearing assembly 222 coupled thereto. In other embodiments, however, the handle 124 may be omitted and operation of the door assembly 500 may instead be accomplished through automation, such as via electromechanical or other indirect means.

A mechanical linkage 502 (alternately referred to as a “linkage”) may be operatively coupled to the door handle 124 via the gearing assembly 222. Similar to the mechanical linkage 220 of FIG. 2, the mechanical linkage 502 may be at least partially embedded within the door 102 and actuatable (movable) to help lift the door 102 upwardly. More specifically, the mechanical linkage 502 may comprise a continuous or semi-continuous structure, and operation (e.g., rotation) of the handle 124 may be converted into linear movement of the mechanical linkage 502 via the gearing assembly 222. Moreover, similar to the mechanical linkage 220, the mechanical linkage 502 may be made of metal, plastic, or another rigid or semi-rigid material.

A lifting mechanism 504 may be positioned at an end of the mechanical linkage 502 and extendable through an aperture 506 defined in the underside 204 of the door 102 when the door handle 124 is actuated. In some embodiments, the lifting mechanism 504 may comprise rolling element, such as a caster or wheel set capable of engaging the underlying surface 122 and rolling as the door 102 is moved from the closed position. In other embodiments, the lifting mechanism 504 may comprise any structure capable of engaging the underlying surface 122 and allowing the door 102 to pivot to and from the closed position. In at least one embodiment, the mechanical linkage 502 may be attached to or partially embedded into the second side 110b of the door. In such embodiments, the lifting mechanism 504 need not extend through the aperture 506 since it may already be positioned on the exterior of the door 102.

In example operation, actuation or rotation of the door handle 124 may drive the gearing assembly 222 against the mechanical linkage 502, which urges the lifting mechanism 504 through the aperture 506 to engage the underlying surface 122. Engaging the underlying surface 122 correspondingly urges the door 102 to move upward. Accordingly, rotating the handle 124 correspondingly lifts the door 102 off the underlying surface 122 and thereby disengages the bottom seal 120 and the profiles 212a,b to allow the door 102 to pivot to the open position. In some embodiments, the door assembly 500 may further include the counterweight system 226 configured to aid in operating the door handle 124 to raise the door 102, as generally described above.

In any of the embodiments discussed herein, a locking mechanism may be included to help secure the door 102 in the closed position. In some embodiments, for example, a locking bolt may be included and otherwise incorporated into any of the door assemblies 100, 400, and 500 to prevent rotation and/or upward movement. In other embodiments, a bolt or another mechanism may protrude from the top of the door 102 and potentially engage a rebate or another fixed part of the wall 106 to prevent upward and/or rotational movement. In yet other embodiments, the locking mechanism may comprise a hook extending from the bottom of the door 102 and capable of being latched to the underlying surface 122 to prevent upward and/or rotational movement.

While the bottom seal 120 is shown and described herein as being mounted to the underside 204 of the door 102 at the bottom 108b, it is contemplated herein to alternatively mount the bottom seal 120 on the underlying surface 122. In either scenario, a sealed interface may be generated when the door 102 is moved downwardly, as generally described above. In yet other embodiments, individual bottom seals 120 may be mounted to both the underside 204 of the door 102 and the underlying surface 122 to ensure a sealed interface is achieved during operation.

Embodiments disclosed herein include:

A. A door assembly that includes a door positionable within an opening defined in a wall, a bottom seal mounted to one of a bottom of the door and an underlying surface to generate a sealed interface at the underlying surface when the door is in a closed position, and a linkage operatively coupled to the door and actuatable to lift the door upwardly relative to the underlying surface and thereby separate the bottom seal from the other of the bottom of the door and the underlying surface.

B. A method that includes actuating a linkage operatively coupled to a door positioned within an opening defined in a wall, and thereby lifting the door upwardly relative to an underlying surface, releasing a sealed engagement between a bottom seal mounted to one of a bottom of the door and the underlying surface as the door is lifted upwardly, and rotating the door from a closed position to an open position.

Each of embodiments A and B may have one or more of the following additional elements in any combination: Element 1: further comprising a lifting hinge pivotably mounting the door to the wall and including a fixed lifting hinge portion coupled to one of the wall and the door and a movable lifting hinge portion rotatably coupled to the fixed lifting hinge portion, wherein the linkage is operatively coupled to the movable lifting hinge portion such that actuation of the linkage urges the movable lifting hinge portion against the fixed lifting hinge portion to lift the door. Element 2: further comprising a handle mounted to the door and operatively coupled to the linkage such that operation of the handle actuates the linkage and thereby urges the movable lifting hinge portion against the fixed lifting hinge portion to lift the door. Element 3: further comprising a lifting mechanism positioned at an end of the linkage, wherein actuation of the linkage urges the lifting mechanism to engage the underlying surface and thereby lift the door upward relative to the underlying surface. Element 4: wherein the lifting mechanism comprises a rolling element. Element 5: further comprising a handle mounted to the door and operatively coupled to the linkage such that operation of the handle actuates the linkage and thereby urges the lifting mechanism against the underlying surface. Element 6: wherein the door includes a top and first and second sides extending between the top and the bottom, the door assembly further comprising a rebate provided in the opening, a top seal interposing the rebate at the top when the door is in the closed position, and first and second side seals interposing the rebate at the first and second sides when the door is in the closed position, wherein the top seal, the first and second side seals, and the bottom seal jointly provide a substantially fluid-tight seal about a substantial periphery of the door when the door is in the closed position. Element 7: further comprising a first rotation prevention member mounted to one of the door and the wall, and a second rotation prevention member extending laterally from a side of the other of the door and the wall and engageable with the first rotation prevention member, wherein, when the door is in the closed position, the second rotation prevention member engages the first rotation prevention member to prevent the door from rotating from the closed position, and wherein, when the door is lifted upwardly, the second rotation prevention member is engageable with a top surface of the first rotation prevention member as the door is rotated from the closed position. Element 8: further comprising a multi-level hinge that pivotably mounts the door to the wall and includes a fixed hinge portion coupled to the wall and a movable hinge portion coupled to the door and pivotably coupled to the fixed hinge portion, and a first profile defined by the fixed hinge portion, and a second profile defined by the movable hinge portion and matable with the first profile, wherein the door is prevented from rotating from the closed position when the first and second profiles are mated, and wherein lifting the door upwardly disengages the first and second profiles and thereby allows the door to rotate from the closed position. Element 9: wherein the door is prevented from dropping downwardly when the first and second profiles are misaligned. Element 10: further comprising a counterweight system operatively coupled to the door and operable to help lift the door upwardly.

Element 11: wherein a lifting hinge pivotably mounts the door to the wall and includes a fixed lifting hinge portion coupled to the wall and a movable lifting hinge portion rotatably coupled to the fixed lifting hinge portion, and wherein actuating the linkage further comprises urging the movable lifting hinge portion against the fixed lifting hinge portion with the linkage to lift the door. Element 12: wherein a handle is mounted to the door and operatively coupled to the linkage, and wherein actuating the linkage further comprises operating the handle to actuate the linkage and thereby urge the movable lifting hinge portion against the fixed lifting hinge portion. Element 13: wherein a lifting mechanism is positioned at an end of the linkage, and wherein actuating the linkage further comprises urging the lifting mechanism toward the underlying surface, and engaging the underlying surface with the lifting mechanism and thereby lifting the door upwardly relative to the underlying surface. Element 14: wherein a handle is mounted to the door and operatively coupled to the linkage such that operation of the handle actuates the linkage and thereby urges the lifting mechanism against the underlying surface. Element 15: wherein the door includes a top and first and second sides extending between the top and the bottom, and a rebate is provided in the opening, the method further comprising sealing an interface between the rebate and the top of the door with a top seal when the door is in the closed position, sealing an interface between the rebate and the first and second sides of the door with first and second side seals when the door is in the closed position, and jointly providing a substantially fluid-tight seal about a substantial periphery of the door with the top seal, the first and second side seals, and the bottom seal when the door is in the closed position. Element 16: wherein a first rotation prevention member extends laterally from a side of one of the door and the wall and is engageable with a second rotation prevention member mounted to the other of the door and the wall, the method further comprising engaging the first rotation prevention member against the second rotation prevention member and thereby preventing the door from rotating from the closed position, lifting the door upwardly and rotating the door from the closed position, and preventing the door from dropping downwardly by engaging the first rotation prevention member against a top surface of the second rotation prevention member as the door is rotated from the closed position. Element 17: wherein the door is also pivotably mounted to the wall with a multi-level hinge including a fixed hinge portion coupled to the wall and a movable hinge portion coupled to the door and pivotably coupled to the fixed hinge portion, the method further comprising preventing the door from rotating from the closed position by mating a first profile defined by the fixed hinge portion with a second profile defined by the movable hinge portion, and disengaging the first and second profiles as the door is lifted and thereby allowing the door to rotate from the closed position. Element 18: further comprising rotating the door back to the closed position, aligning the first and second profiles and thereby allowing the door to drop, and restoring the sealed engagement between the bottom seal and the other of the door and the underlying surface as the door drops. Element 19: further comprising helping lift the door upwardly with a counterweight system operatively coupled to the linkage.

By way of non-limiting example, exemplary combinations applicable to A and B include: Element 1 with Element 2; Element 3 with Element 4; Element 3 with Element 5; Element 8 with Element 9; Element 11 with Element 12; Element 13 with Element 14; and Element 17 with Element 18.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Although various example embodiments have been disclosed, a worker of ordinary skill in this art would recognize that certain modifications would come within the scope of this disclosure. For that reason, the following claims should be studied to determine the scope and content of this disclosure.

What is claimed is:

1. A door assembly, comprising:
a door positionable within an opening defined in a wall;
a bottom seal mounted to one of a bottom of the door and an underlying surface to generate a sealed interface at the underlying surface when the door is in a closed position; and
a linkage operatively coupled to the door and actuatable to lift the door upwardly relative to the underlying surface and thereby separate the bottom seal from the other of the bottom of the door and the underlying surface.

2. The door assembly of claim 1, further comprising a lifting hinge pivotably mounting the door to the wall and including a fixed lifting hinge portion coupled to one of the wall and the door and a movable lifting hinge portion rotatably coupled to the fixed lifting hinge portion,
wherein the linkage is operatively coupled to the movable lifting hinge portion such that actuation of the linkage urges the movable lifting hinge portion against the fixed lifting hinge portion to lift the door.

3. The door assembly of claim 2, further comprising a handle mounted to the door and operatively coupled to the linkage such that operation of the handle actuates the linkage and thereby urges the movable lifting hinge portion against the fixed lifting hinge portion to lift the door.

4. The door assembly of claim 1, further comprising a lifting mechanism positioned at an end of the linkage, wherein actuation of the linkage urges the lifting mechanism to engage the underlying surface and thereby lift the door upward relative to the underlying surface.

5. The door assembly of claim 4, wherein the lifting mechanism comprises a rolling element.

6. The door assembly of claim 4, further comprising a handle mounted to the door and operatively coupled to the linkage such that operation of the handle actuates the linkage and thereby urges the lifting mechanism against the underlying surface.

7. The door assembly of claim 1, wherein the door includes a top and first and second sides extending between the top and the bottom, the door assembly further comprising:
a rebate provided in the opening;
a top seal interposing the rebate at the top when the door is in the closed position; and
first and second side seals interposing the rebate at the first and second sides when the door is in the closed position,
wherein the top seal, the first and second side seals, and the bottom seal jointly provide a substantially fluid-tight seal about a substantial periphery of the door when the door is in the closed position.

8. The door assembly of claim 1, further comprising:
a first rotation prevention member mounted to one of the door and the wall; and
a second rotation prevention member extending laterally from a side of the other of the door and the wall and engageable with the first rotation prevention member,
wherein, when the door is in the closed position, the second rotation prevention member engages the first rotation prevention member to prevent the door from rotating from the closed position, and
wherein, when the door is lifted upwardly, the second rotation prevention member is engageable with a top surface of the first rotation prevention member as the door is rotated from the closed position.

9. The door assembly of claim 1, further comprising:
a multi-level hinge that pivotably mounts the door to the wall and includes a fixed hinge portion coupled to the wall and a movable hinge portion coupled to the door and pivotably coupled to the fixed hinge portion; and
a first profile defined by the fixed hinge portion, and a second profile defined by the movable hinge portion and matable with the first profile,
wherein the door is prevented from rotating from the closed position when the first and second profiles are mated, and
wherein lifting the door upwardly disengages the first and second profiles and thereby allows the door to rotate from the closed position.

10. The door assembly of claim 9, wherein the door is prevented from dropping downwardly when the first and second profiles are misaligned.

11. The door assembly of claim 1, further comprising a counterweight system operatively coupled to the door and operable to help lift the door upwardly.

12. A method, comprising:
actuating a linkage operatively coupled to a door positioned within an opening defined in a wall, and thereby lifting the door upwardly relative to an underlying surface;
releasing a sealed engagement between a bottom seal mounted to one of a bottom of the door and the underlying surface as the door is lifted upwardly; and
rotating the door from a closed position to an open position.

13. The method of claim 12, wherein a lifting hinge pivotably mounts the door to the wall and includes a fixed lifting hinge portion coupled to the wall and a movable lifting hinge portion rotatably coupled to the fixed lifting hinge portion, and wherein actuating the linkage further comprises:
urging the movable lifting hinge portion against the fixed lifting hinge portion with the linkage to lift the door.

14. The method of claim 13, wherein a handle is mounted to the door and operatively coupled to the linkage, and wherein actuating the linkage further comprises:
operating the handle to actuate the linkage and thereby urge the movable lifting hinge portion against the fixed lifting hinge portion.

15. The method of claim 12, wherein a lifting mechanism is positioned at an end of the linkage, and wherein actuating the linkage further comprises:
urging the lifting mechanism toward the underlying surface; and
engaging the underlying surface with the lifting mechanism and thereby lifting the door upwardly relative to the underlying surface.

16. The method of claim 15, wherein a handle is mounted to the door and operatively coupled to the linkage such that operation of the handle actuates the linkage and thereby urges the lifting mechanism against the underlying surface.

17. The method of claim 12, wherein the door includes a top and first and second sides extending between the top and the bottom, and a rebate is provided in the opening, the method further comprising:
sealing an interface between the rebate and the top of the door with a top seal when the door is in the closed position;
sealing an interface between the rebate and the first and second sides of the door with first and second side seals when the door is in the closed position; and
jointly providing a substantially fluid-tight seal about a substantial periphery of the door with the top seal, the first and second side seals, and the bottom seal when the door is in the closed position.

18. The method of claim 12, wherein a first rotation prevention member extends laterally from a side of one of the door and the wall and is engageable with a second rotation prevention member mounted to the other of the door and the wall, the method further comprising:
engaging the first rotation prevention member against the second rotation prevention member and thereby preventing the door from rotating from the closed position;
lifting the door upwardly and rotating the door from the closed position; and
preventing the door from dropping downwardly by engaging the first rotation prevention member against a top surface of the second rotation prevention member as the door is rotated from the closed position.

19. The method of claim 12, wherein the door is also pivotably mounted to the wall with a multi-level hinge including a fixed hinge portion coupled to the wall and a movable hinge portion coupled to the door and pivotably coupled to the fixed hinge portion, the method further comprising:
preventing the door from rotating from the closed position by mating a first profile defined by the fixed hinge portion with a second profile defined by the movable hinge portion; and
disengaging the first and second profiles as the door is lifted and thereby allowing the door to rotate from the closed position.

20. The method of claim 19, further comprising:
rotating the door back to the closed position;
aligning the first and second profiles and thereby allowing the door to drop; and
restoring the sealed engagement between the bottom seal and the other of the door and the underlying surface as the door drops.

21. The method of claim 12, further comprising helping lift the door upwardly with a counterweight system operatively coupled to the linkage.
